(19) United States
(12) Patent Application Publication
(10) Pub. No.: US 2018/0336143 A1
(43) Pub. Date: Nov. 22, 2018

(54) CONCURRENT CACHE MEMORY ACCESS

(71) Applicant: Microsoft Technology Licensing, LLC, Redmond, WA (US)

(72) Inventors: Patrick P. LAI, Fremont, CA (US); Robert Allen SHEARER, Woodinville, WA (US)

(21) Appl. No.: 15/601,802

(22) Filed: May 22, 2017

(51) Int. Cl. G06F 12/128; G06F 12/0811; G06F 12/0808; G06F 15/78

(52) U.S. Cl. CPC G06F 12/128; G06F 12/0811; G06F 12/0808; G06F 2212/621; G06F 2212/69; G06F 2212/283; G06F 15/781

(57) ABSTRACT

A first cache is paired at the same cache level with a second, higher capacity, but slower, cache. Access to both caches is performed in parallel and whichever cache hits and returns the data first is considered a valid cache read-hit. The higher capacity cache is configured to have multiple power saving modes while also having a high level of associativity in order to minimize conflicts and capacity misses. Transfers can move cache lines between the two caches at the same level (i.e., without crossing a large inter-cache level or inter-processor fabric) in order to adapt to changing access patterns. This functionality allows a balancing/trade-off between access latency and power consumption.

### BACKGROUND

Integrated circuits, and systems-on-a-chip (SoC) may include multiple independent processing units (a.k.a., “cores”) that read and execute instructions. These multi-core processing chips typically cooperate to implement multiprocessing. To facilitate this cooperation and to improve performance, multiple levels of cache memories may be used to help bridge the gap between the speed of these processors and main memory.

### SUMMARY

Examples discussed herein relate to an apparatus for processing data that includes a first cache memory, a second cache memory, and a cache controller. The first cache memory includes first cache storage array and a first cache tag array. The second cache memory includes a second cache storage array and a second cache tag array. The second cache storage array has a higher storage capacity than the first cache storage array. The second cache memory has a plurality of operating modes each having a different power consumption and corresponding different latency to access the second cache memory. The cache controller is coupled to the first cache memory and the second cache memory to respond to cache access requests for data blocks. The cache controller is to perform cache lookups in the first cache memory and the second cache memory concurrently.

In another example, a method of operating a cache memory system includes storing a cache line in at least one of a first cache memory and a second cache memory. The first cache memory having a first cache storage array and a first cache tag array. The second cache memory having a second cache storage array and a second cache tag array. The method further includes setting an operating mode of the second cache memory to a first one of a plurality of operating modes. The plurality of operating modes each having a different power consumption and corresponding different latency to access the second cache memory. The method further includes concurrently performing cache lookups for the cache line in the first cache memory and the second cache memory. The cache line is received from the one of the first cache memory and the second cache memory that returns the cache line first.

In another example, an integrated circuit includes a first cache memory, a second cache memory, and a cache controller. The first cache memory has a first access latency. The second cache memory has a variable access latency that is based on an operating mode of the second cache memory. The cache controller is coupled to the first cache memory and the second cache memory. The cache is controller configured such that, for a majority of cache accesses, the first cache memory and the second cache memory perform cache lookups concurrently.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 is a block diagram of a processing system that includes fast and slow caches at the same cache level that are queried concurrently.

FIGS. 2A-2B are diagrams that illustrate, for an exclusive configuration, an eviction of a cache line from the fast cache to a slow cache at the same cache level.

FIGS. 3A-3B are diagrams that illustrate, for an inclusive configuration, a promotion of a cache line from the slow cache to a fast cache at the same cache level.

FIG. 4 is a flowchart illustrating a method of operating a cache memory system.

FIG. 5 is a flowchart illustrating a method of operating an exclusive cache memory system.

FIG. 6 is a block diagram of a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or an integrated circuit.

In an embodiment, a fast, low latency cache is paired at the same cache level with a large, low power, but slower, cache. Access to both caches is performed in parallel and whichever cache hits and returns the data first is considered a valid cache read-hit. The slower cache is configured to have multiple power saving modes while also having a large level of associativity in order to minimize conflicts and capacity missed. Transfers can move cache lines between the two caches at the same level (i.e., without crossing a large inter-cache level or inter-processor fabric) in order to adapt to changing access patterns. This functionality/architecture allows a balancing and or trade-offs between access latency and power consumption to be made.

As used herein, the term “processor” includes digital logic that executes operational instructions to perform a sequence of tasks. The instructions can be stored in firmware or software, and can represent anywhere from a very limited to a very general instruction set. A processor can be one of several “cores” (a.k.a., ‘core processors’) that are collocated on a common die or integrated circuit (IC) with other processors. In a multiple processor (“multi-processor”) system, individual processors can be the same as or different than other processors, with potentially different performance characteristics (e.g., operating speed, heat dissipation, cache sizes, pin assignments, functional capabilities, and so forth). A set of “asymmetric” or “heterogeneous” processors refers to a set of two or more processors, where at least two processors in the set have different performance capabilities (or benchmark data). A set of “symmetric” or “homogeneous” processors refers to a set of two or more processors, where all of the processors in the set have the same performance capabilities (or benchmark data). As used in the claims below, and in the other parts of this disclosure, the terms “processor”, “processor core”, and “core processor”, or simply “core” will generally be used interchangeably.

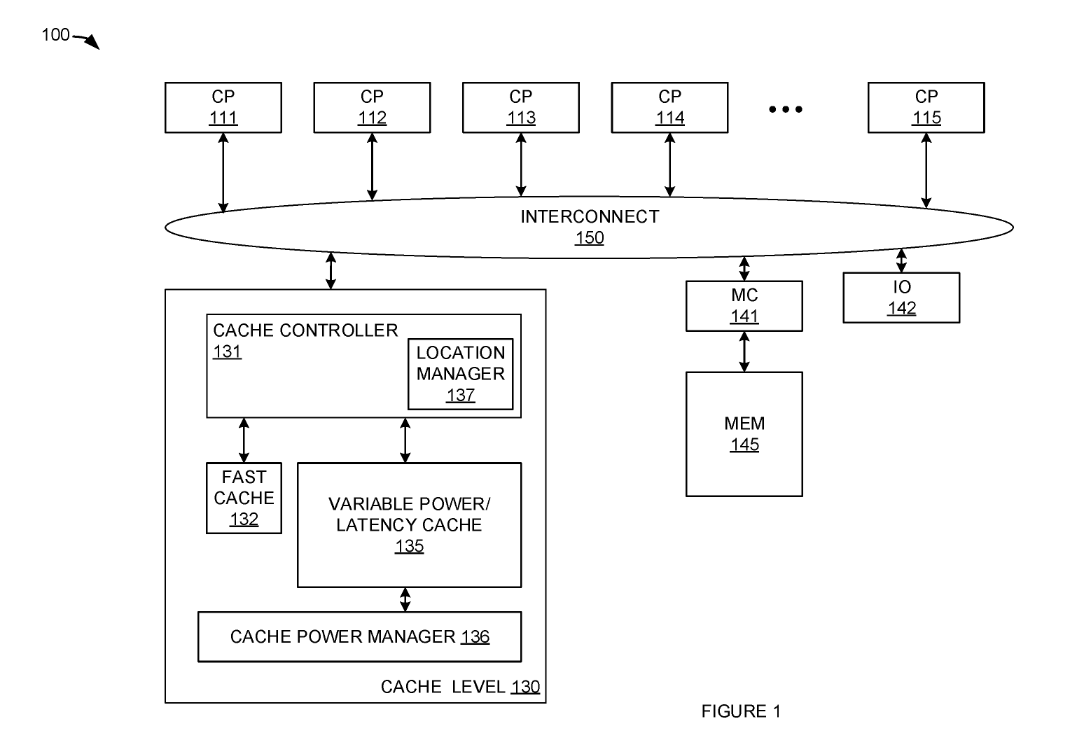

FIG. 1 is a block diagram of a processing system that includes fast and slow caches at the same cache level that are queried concurrently. In FIG. 1, processing system 100 includes core processor (CP) 111, core processor 112, core processor 113, core processor 114, core processor 115, cache level 130, interconnect 150, memory controller 141, input/output (TO) processor 142, and main memory 145. Processing system 100 may include additional processors, interfaces, caches, and IO processors (not shown in FIG. 1.)

Core processor 111 is operatively coupled to interconnect 150. Core processor 112 is operatively coupled to interconnect 150. Core processor 113 is operatively coupled to interconnect 150. Core processor 114 is operatively coupled interconnect 150. Core processor 115 is operatively coupled to interconnect 150. Memory controller 141 is operatively coupled to interconnect 150 and to main memory 145. IO processor 142 is operatively coupled to interconnect 150.

Thus, for the example embodiment illustrated in FIG. 1, it should be understood that the elements of processing system 100 are arranged in ‘crossbar’ interconnect topology. Other network topologies (e.g., mesh, ring, star, hybrid(s), etc.) may be employed by processing system 100.

Interconnect 150 operatively couples processors 111-115, memory controller 141, and IO processor 142 to each other and to cache level 130. Thus, data access operations (e.g., load, stores) and cache operations (e.g., snoops, evictions, flushes, etc.), by a processor 111-115, cache level 130, memory controller 141, and/or IO processor 142 may be exchanged with each other via interconnect 150.

Cache level 130 includes cache controller 131, fast cache 132, variable power cache 135, and cache power manager 136. Cache controller 131 includes cache line location manager 137. Fast cache 132 can be a fast, low latency cache. In an embodiment, fast cache 132 may be sized and have a latency similar to a level 1 (L1) cache that typically resides close to, or within, a processor 111-115. Variable power cache 135 can be a very big (relative to fast cache 132), and very slow (relative to fast cache 132) cache. In an embodiment, variable power cache 135 may be sized and have a latency similar to last-level or memory side caches. Variable power cache 135 is configured to provide a very large storage capacity in order to reduce cache misses. Variable power cache 135 is also configured for low power consumption. Variable power cache 135 may have a plurality of power saving features and/or modes that are controlled by power manager 136 and/or processors 111-115. These power saving features and/or modes may include, but are not limited to, a low power supply voltage, variable power supply voltage modes, sleep mode, deep sleep mode, etc. Each of these power saving modes will typically result in respectively different access latencies. Thus, some speed versus power consumption tradeoffs for variable power cache 135 may be made, situationally, by power manager 136 and/or processors 111-115.

Cache controller 131 is operatively coupled to fast cache 132 and variable power cache 135. When an access request (e.g., read, write), is received, cache controller 131 directs fast cache 132 and variable power cache 135 to determine, concurrently with each other, whether the respective fast cache 132 and/or variable power cache 135 contains a copy of the cache line associated with the request. If both of fast cache 132 and variable power cache 135 hold a copy of the requested cache line, controller 131 uses the result (e.g., cache line data) from the first one of fast cache 132 and variable power cache 135 to return the result. In this manner, if the requested line is only in fast cache 132, controller 131 will use the cache line returned by fast cache 132. If the requested line is only in variable power cache 135, controller 131 will use the cache line returned by variable power cache 135. If the requested line is in neither fast cache 132 or variable power cache 135, controller 131 can then send a request for the cache line (and/or a data block that contains the requested cache line) to interconnect 150 and/or memory controller 141.

Cache controller 131 includes location manager 137. Location manager 137 controls the transfers of cache line blocks between fast cache 132 and variable power cache 135. Location manager 137 may move (or copy) cache lines between fast cache 132 and variable power cache 135 based on algorithms such as least-recently-used (LRU) and/or most recently used (MRU). In this manner, frequently used blocks can be transferred to fast cache 132 to minimize access times. Blocks no longer in active and/or frequently used can be placed in variable power cache 135.

In an embodiment, location manager is configured (either by design or a settable mode) to move cache lines between fast cache 132 and variable power cache 135 in either an inclusive or exclusive manner. If the configuration is inclusive, copies of a cache line or data block that is in fast cache 132 is also in variable power cache 135. This helps save power by decreasing transfers between fast cache 132 and variable power cache 135 (e.g., when a cache line is evicted from fast cache 132.) If the configuration is exclusive, a cache line can only reside in one of fast cache 132 and variable power cache 135.

In an embodiment of an exclusive configuration, fast cache 132 and variable power cache 135 may have the same number of congruence classes (i.e., ‘cache ways’ or ‘ways’) This simplifies transfers between fast cache 132 and variable power cache 135. By having the same number of congruence classes, cache controller 131 can transfer a cache line by moving that cache line from a given set (e.g., set S) to the same set (S) of the other cache without further processing because the mapping of cache lines to sets is identical. In the exclusive configuration, if a cache line is evicted from fast cache 132 due to a lack of use, location manager 137 can transfer the cache line to variable power cache 135. If a cache line is resident in variable power cache 135, and location manager 137 determines an access threshold (e.g., number of read hits and/or number of write hits) has been met, location manager 137 can transfer the cache line to fast cache 132 (and evict that cache line from variable power cache 135.)

In an embodiment of an inclusive configuration, variable power cache 135 inclusively holds all the cache lines that fast cache 132 holds. On reads, the first of fast cache 132 and variable power cache 135 to return a read-hit determines the supplier of the cache line. On a write, after a lookup completes on both caches it will be known whether the cache line is in both fast cache 132 and variable power cache 135, or only variable power cache 135. If the cache line is in both fast cache 132 and variable power cache 135, both copies are updated with the write data. If the cache line is only in variable power cache 135, only variable power cache 135 is updated.

If fast cache 132 is evicting a cache line, cache controller 131 can complete the eviction without transferring the cache line to variable power cache 135 because variable power cache 135 already has a copy. If variable power cache 135 is evicting a cache line due to a lack of use, fast cache 132 should not need to be updated because fast cache 132 should have already evicted the cache line due to a stricter lack-of-use requirement (necessitated by the smaller capacity of fast cache 132.) If a cache line in variable power cache 135 reaches an access threshold, location manager 137 copies the cache line to fast cache 132 without invalidating the cache line in variable power cache 135.

In an embodiment, a fast cache 132 includes a cache storage array and a cache tag array. Likewise, variable power cache 135 includes a second cache storage array and a cache tag array. The cache storage and cache tag arrays for fast cache 132 and variable power cache 135 are separate and distinct from each other (e.g., different designs, sizes, power consumption latency, layout, etc.) Variable power cache 135's cache storage array typically has a higher storage capacity than fast cache 132's cache storage array. Variable power cache 135 has a plurality of operating modes that each have different power consumption and correspondingly different latency to access. Thus, variable power cache 135 has settable modes that allow tradeoffs between speed and power consumption to be made while variable power cache 135 is operating. Cache controller 131 responds to cache access requests (e.g., from a processor 111-115) for data blocks.

Cache controller 131 performs cache lookups in the fast cache 132 and variable power cache 135 in parallel (i.e., concurrently.) If fast cache 132 returns data in response to a cache access request before variable power cache 135 returns the data in response to the cache access request, cache controller 131 uses the data from fast cache 132. If variable power cache 135 returns data in response to a cache access request before fast cache 132 returns the data in response to the cache access request, cache controller 131 uses the data from variable power cache 135.

Cache controller 131 may be configured such that any given cache line is stored in only one of fast cache 132 and variable power cache 135. This is known as an exclusive cache scheme. When cache level 130 is configured to be exclusive, if a cache line is evicted from fast cache 132, the cache line is stored by cache controller 131 in variable power cache 135. If a cache line in variable power cache 135 meets an access threshold, the cache line is evicted from variable power cache 135 and stored in fast cache 132.

Cache controller 131 may be configured such that any given cache line may be stored in both fast cache 132 and variable power cache 135. This is known as an inclusive cache scheme. When cache level 130 is configured to be inclusive, if a cache line is evicted from fast cache 132, cache controller 131 need not make any updates to variable power cache 135 because that cache line should still be available in variable power cache 135. If a cache line in variable power cache 135 meets an access threshold, the cache line is stored in fast cache 132 without evicting the cache line from variable power cache 135.

In an embodiment, cache controller 131 stores a cache line in at least one of fast cache 132 and variable power cache 135. Power manager 136 sets variable power cache 135 to a given operating mode, where the various operating modes variable power cache 135 may be set to operate in each have a different power consumption and corresponding different latency to access variable power cache 135. When cache controller receive a cache access request for the cache line, cache controller 131 concurrently performs cache lookups for the cache line in fast cache 132 and variable power cache 135. Cache controller 131 receives (and uses) the cache line from the one of fast cache 132 and variable power cache 135 that returned the cache line first (if at all).

When the cache line is being stored in fast cache 132, cache controller 131 may, in response to evicting the cache line from fast cache 132, store the cache line in variable power cache 135. When the cache line is being stored in variable power cache 135, cache controller 131 may, in response to determining that the cache line meets an access threshold, evict the cache line from variable power cache 135 and store the cache line in fast cache 132. When the cache line is stored in the fast cache 132 and is not stored in variable power cache 135, cache controller 131 may, in response to evicting the cache line from fast cache 132, store the cache line in variable power cache 135. When the cache line is stored in variable power cache 135 and is not stored in fast cache 132, cache controller 131 may, in response to determining that the cache line meets an access threshold, store the cache line in fast cache 132 without evicting the cache line from variable power cache 135.

In an embodiment, cache level 130 is included in an integrated circuit. Cache level 130 includes fast cache 132 that has a first access latency. Cache level 130 also includes variable power cache 135 that has a variable access latency. The variable access latency of variable power cache 135 is based on an operating mode of variable power cache 135. Cache level 130 also includes cache controller 131 which is coupled to fast cache 132 and variable power cache 135. Cache controller 131 may be configured such that, for a majority of cache accesses, fast cache 132 and variable power cache 135 perform cache lookups concurrently.

Cache controller 131 may be configured to maintain cache lines exclusively in one of fast cache 132 and variable power cache 135. When configured for ‘exclusive’ operation, if a cache line is evicted from fast cache 132, the cache lines is then stored in variable power cache 135 in response to the cache line being evicted from fast cache 132. When configured for ‘exclusive’ operation, if a cache line in variable power cache 135 meets an access threshold, the cache line is evicted from variable power cache 135 and is then stored in the fast cache 132 in response to the cache line meeting the access threshold. When not configured for ‘exclusive’ operation, if a cache line in variable power cache 135 meets an access threshold, the cache line is stored in fast cache 132 in response to the cache line meeting the access threshold and the cache line is not evicted from variable power cache 135 in response to the storing of the cache line in fast cache 132.

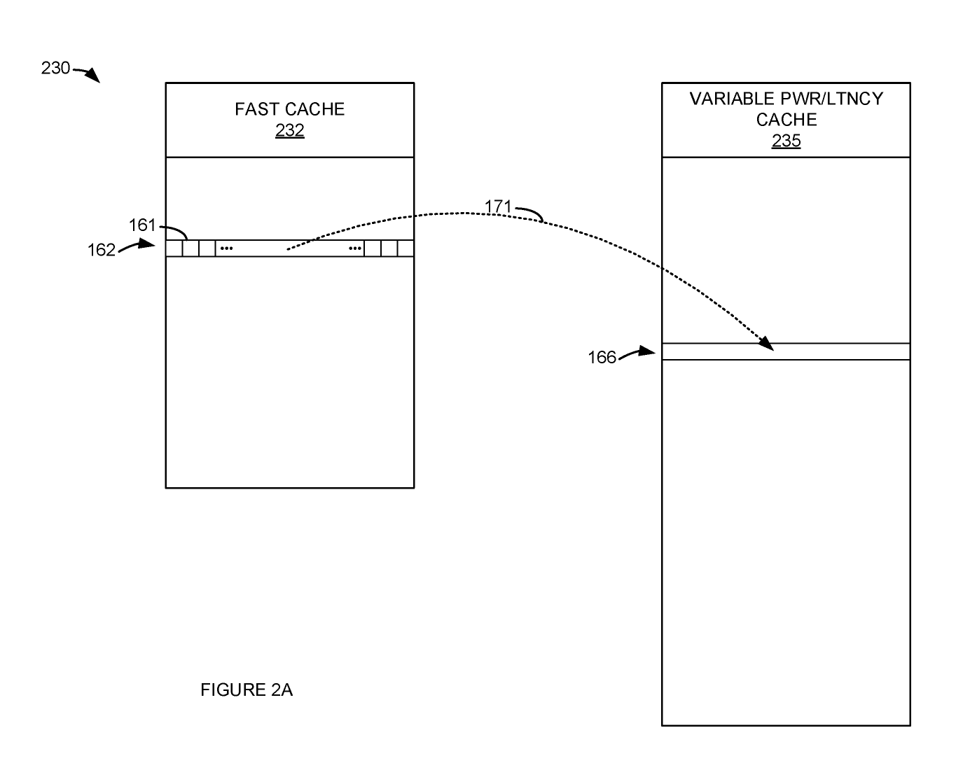

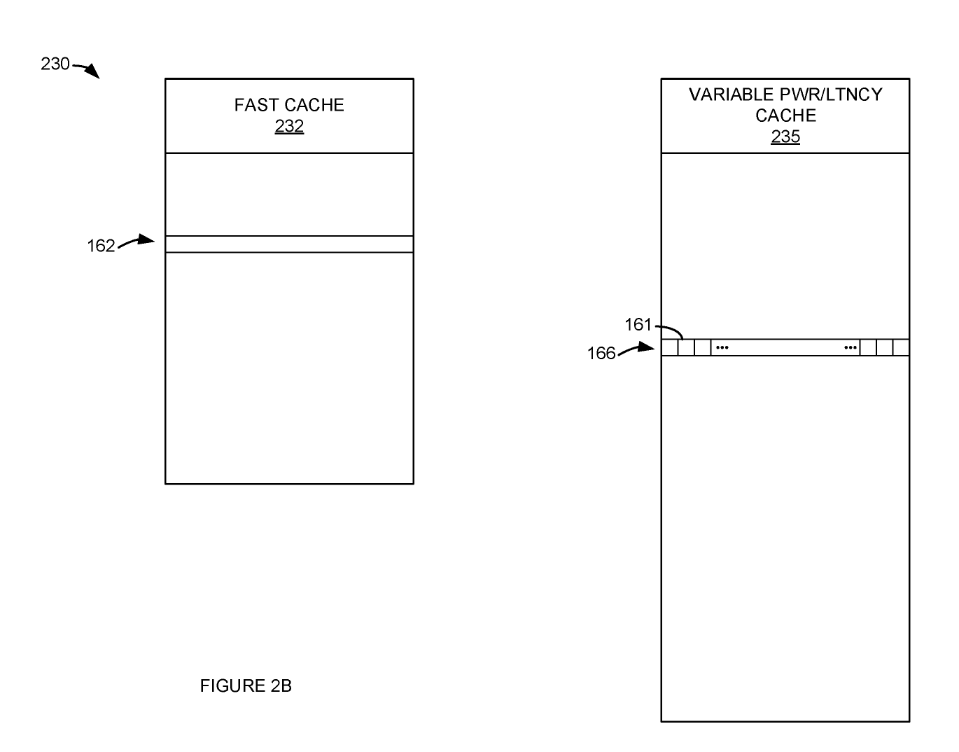

FIGS. 2A-2B are diagrams that illustrate, for an exclusive configuration, an eviction of a cache line from the fast cache to a slow cache at the same cache level. In FIGS. 2A-2B, cache level 230 includes fast cache 232 and variable power cache 235. Cache level 230 may be, or correspond to, cache level 130 of system 100. Fast cache 232 is illustrated as storing cache line data 161 in cache line storage 162. Fast cache 232 is controlled to evict cache line data 161. In response to the eviction of cache line data 161, cache line data 161 is copied to cache line storage 166 of variable power cache 235. This is illustrated in FIG. 2A by arrow 171. After the eviction of cache line data 161 from cache line storage 162 of fast cache 232, variable power cache 235 holds cache line data 161 in cache line storage 166. This is illustrated in FIG. 2B.

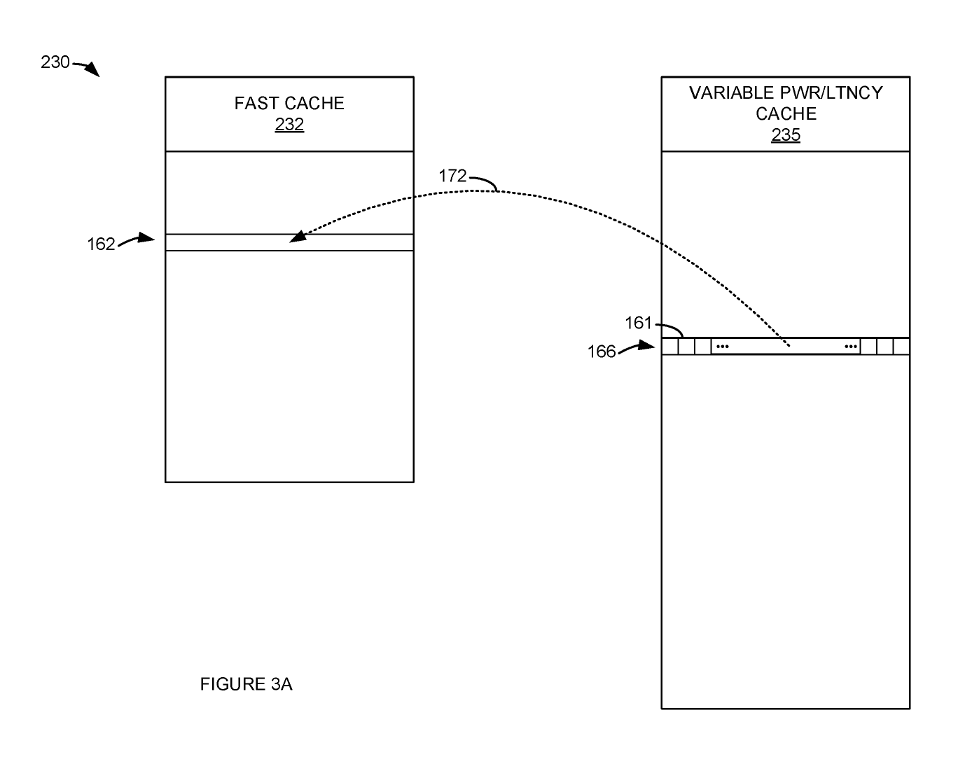

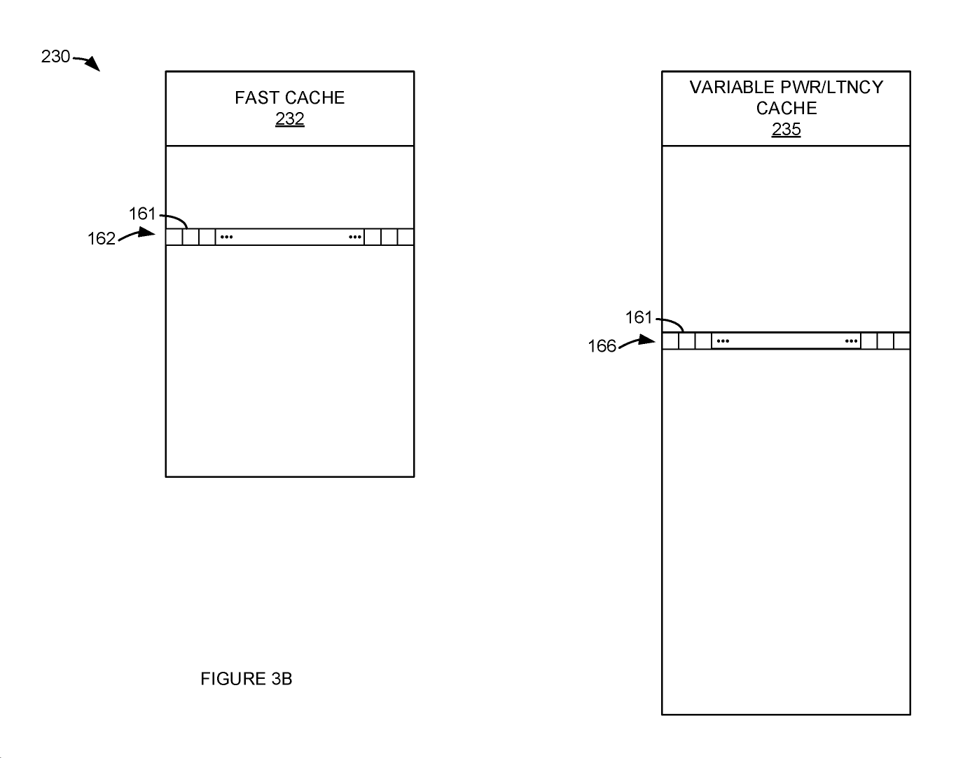

FIGS. 3A-3B are diagrams that illustrate, for an inclusive configuration, a promotion of a cache line from the slow cache to a fast cache at the same cache level. In FIGS. 3A-3B, cache level 230 includes fast cache 232 and variable power cache 235. Cache level 230 may be, or correspond to, cache level 130 of system 100. Variable power cache 235 is illustrated as storing cache line data 161 in cache line storage 166. Variable power cache 235 is controlled to promote cache line data 161. In response to the promotion of cache line data 161, cache line data 161 is copied to cache line storage 162 of fast cache 232. This is illustrated in FIG. 3A by arrow 172. After the promotion of cache line data 161 from cache line storage 166 of variable power cache 235, both fast cache 232 and variable power cache 235 hold cache line data 161 in cache line storage 162 and cache line storage 166, respectively. This is illustrated in FIG. 3B.

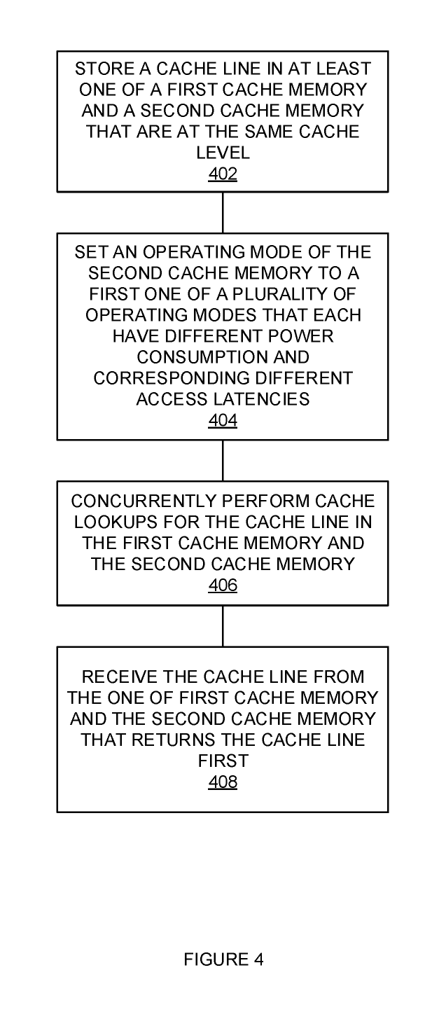

FIG. 4 is a flowchart illustrating a method of operating a cache memory system. The steps illustrated in FIG. 4 may be performed, for example, by one or more elements of processing system 100, cache level 130, cache level 230, and/or their components. A cache line is stored in at least one of a first cache memory and a second cache memory that are at the same cache level (402). For example, cache line data 161 may be stored in cache line storage 162 of fast cache 232 and/or cache line data 161 may be stored cache line storage 166 of variable power cache 235.

An operating mode of the second cache memory is set to a first one of a plurality of operating modes that each have different power consumption and corresponding different access latencies (404). For example, cache power manager 136 may control one or more power saving features and/or modes that affect the power consumption (and latency) of variable power cache 135. These power saving features and/or modes may include, but are not limited to, a low power supply voltage, variable power supply voltage modes, sleep mode, deep sleep mode, etc.

Cache lookups for the cache line are performed concurrently in the first cache memory and the second cache memory (406). For example, when an access request (e.g., read, write), is received, cache controller 131 may direct fast cache 132 and variable power cache 135 to determine, concurrently with each other, whether the respective fast cache 132 and/or variable power cache 135 contains a copy of the cache line associated with the request.

The cache line is received from the one of the first cache memory and the second cache memory that returns the cache line first (408). For example, if both of fast cache 132 and variable power cache 135 hold a copy of the requested cache line, controller 131 will receive and use the result (e.g., cache line data) from the first one of fast cache 132 and variable power cache 135 to return the result. In this manner, if the requested line is only in fast cache 132, controller 131 will use the cache line returned by fast cache 132. If the requested line is only in variable power cache 135, controller 131 will use the cache line returned by variable power cache 135. If the requested line is in neither fast cache 132 or variable power cache 135, controller 131 can then send a request for the cache line (and/or a data block that contains the requested cache line) to interconnect 150 and/or memory controller 141.

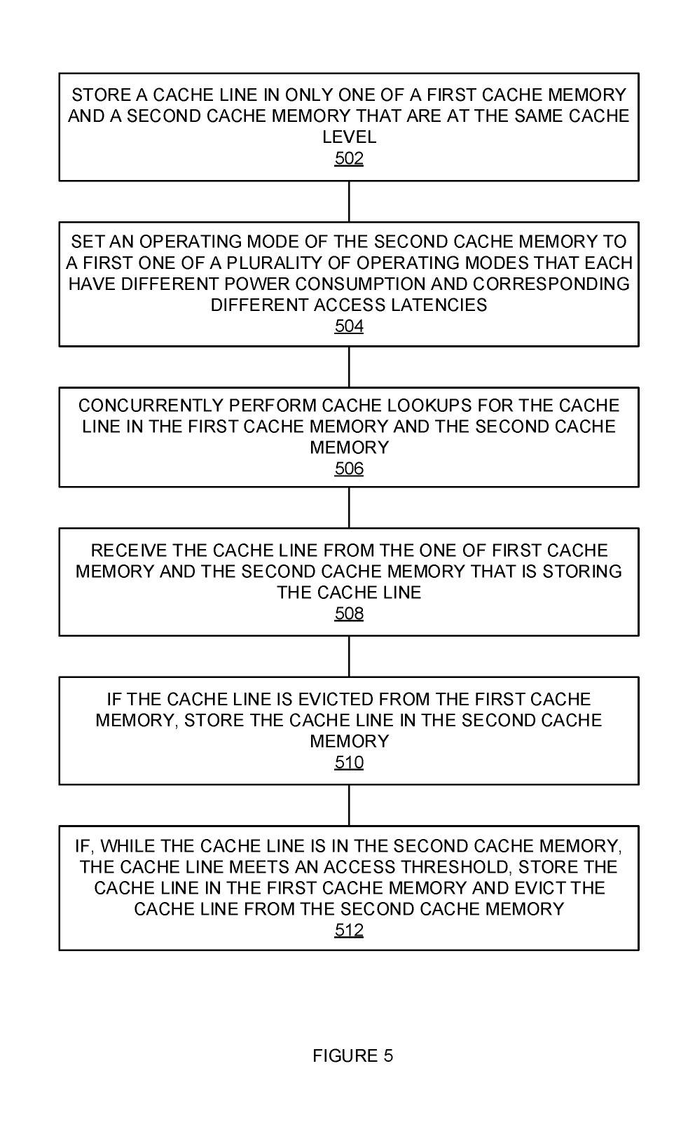

FIG. 5 is a flowchart illustrating a method of operating an exclusive cache memory system. The steps illustrated in FIG. 5 may be performed, for example, by one or more elements of processing system 100, cache level 130, cache level 230, and/or their components. A cache line is stored in only one of a first cache memory and a second cache memory that are at the same cache level (502). For example, cache controller 131 of cache level 130 may be configured to store cache lines in only one of fast cache 132 and variable power cache 135.

An operating mode of the second cache memory is set to a first one of a plurality of operating modes that each have different power consumption and corresponding different access latencies (504). For example, cache power manager 136 may control one or more power saving features and/or modes that affect the power consumption (and latency) of variable power cache 135. These power saving features and/or modes may include, but are not limited to, a low power supply voltage, variable power supply voltage modes, sleep mode, deep sleep mode, etc.

Cache lookups are performed concurrently for the cache line in the first cache memory and the second cache memory (506). For example, when an access request (e.g., read, write), is received, cache controller 131 may direct fast cache 132 and variable power cache 135 to determine, concurrently with each other, whether the respective fast cache 132 and/or variable power cache 135 contains a copy of the cache line associated with the request.

The cache line is received from the one of the first cache memory and the second cache memory that is storing the cache line (508). For example, if the requested line is only in fast cache 132, controller 131 can use the cache line returned by fast cache 132. If the requested line is only in variable power cache 135, controller 131 can use the cache line returned by variable power cache 135. If the requested line is in neither fast cache 132 or variable power cache 135, controller 131 can then send a request for the cache line (and/or a data block that contains the requested cache line) to interconnect 150 and/or memory controller 141.

If the cache line is evicted from the first cache memory, the cache line is stored in the second cache memory (510). For example, if the cache line is in the first cache memory, it will not be in the second cache memory because of the operating condition expressed by box 502. Thus, for example, if the cache line is evicted from fast cache 132 due to a lack of use, location manager 137 transfers the cache line to variable power cache 135.

If, while the cache line is in the second cache memory, the cache line meets an access threshold, the cache line is stored in the first cache memory and evicted from the second cache memory (512). For example, if a cache line is resident in variable power cache 135, and location manager 137 determines an access threshold (e.g., number of read hits and/or number of write hits) has been met, location manager 137 transfers the cache line to fast cache 132 and removes that cache line from variable power cache 135.

The methods, systems and devices described herein may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of processing system 100, cache level 130, cache level 230, and/or their components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), multi-core processors, graphics processing units (GPUs), etc.

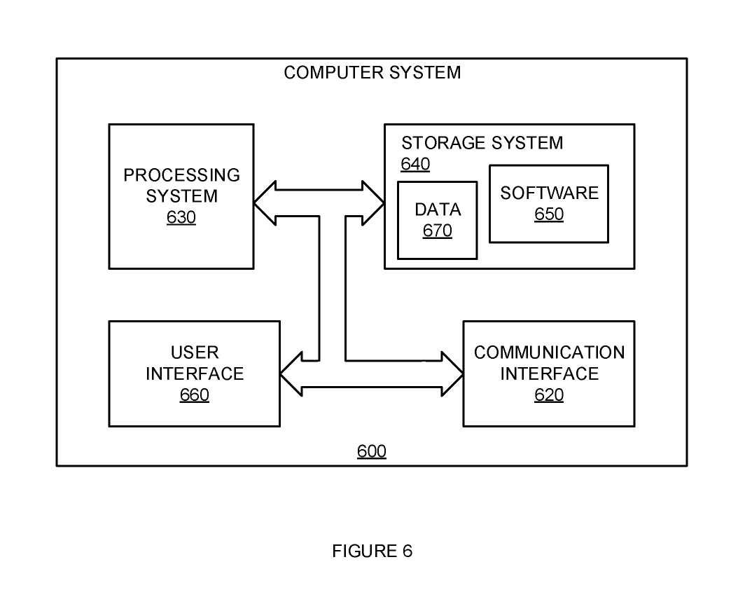

FIG. 6 is a block diagram of a computer system. In an embodiment, computer system 600 and/or its components include circuits, software, and/or data that implement, or are used to implement, the methods, systems and/or devices illustrated in the Figures, the corresponding discussions of the Figures, and/or are otherwise taught herein.

FIG. 6 illustrates a block diagram of an example computer system. In an embodiment, computer system 600 and/or its components include circuits, software, and/or data that implement, or are used to implement, the methods, systems and/or devices illustrated in the Figures, the corresponding discussions of the Figures, and/or are otherwise taught herein.

Computer system 600 includes communication interface 620, processing system 630, storage system 640, and user interface 660. Processing system 630 is operatively coupled to storage system 640. Storage system 640 stores software 650 and data 670. Processing system 630 is operatively coupled to communication interface 620 and user interface 660. Processing system 630 may be an example of one or more of processing system 100, and/or its components.

Computer system 600 may comprise a programmed general-purpose computer. Computer system 600 may include a microprocessor. Computer system 600 may comprise programmable or special purpose circuitry. Computer system 600 may be distributed among multiple devices, processors, storage, and/or interfaces that together comprise elements 620-670.

Communication interface 620 may comprise a network interface, modem, port, bus, link, transceiver, or other communication device. Communication interface 620 may be distributed among multiple communication devices. Processing system 630 may comprise a microprocessor, microcontroller, logic circuit, or other processing device. Processing system 630 may be distributed among multiple processing devices. User interface 660 may comprise a keyboard, mouse, voice recognition interface, microphone and speakers, graphical display, touch screen, or other type of user interface device. User interface 660 may be distributed among multiple interface devices. Storage system 640 may comprise a disk, tape, integrated circuit, RAM, ROM, EEPROM, flash memory, network storage, server, or other memory function. Storage system 640 may include computer readable medium. Storage system 640 may be distributed among multiple memory devices.

Processing system 630 retrieves and executes software 650 from storage system 640. Processing system 630 may retrieve and store data 670. Processing system 630 may also retrieve and store data via communication interface 620. Processing system 650 may create or modify software 650 or data 670 to achieve a tangible result. Processing system may control communication interface 620 or user interface 660 to achieve a tangible result. Processing system 630 may retrieve and execute remotely stored software via communication interface 620.

Software 650 and remotely stored software may comprise an operating system, utilities, drivers, networking software, and other software typically executed by a computer system. Software 650 may comprise an application program, applet, firmware, or other form of machine-readable processing instructions typically executed by a computer system. When executed by processing system 630, software 650 or remotely stored software may direct computer system 600 to operate as described herein.

Implementations discussed herein include, but are not limited to, the following examples:

### Example 1

An apparatus for processing data, comprising: a first cache memory comprising a first cache storage array and a first cache tag array; a second cache memory comprising a second cache storage array and a second cache tag array, the second cache storage array having a higher storage capacity than the first cache storage array, the second cache memory having a plurality of operating modes each having a different power consumption and corresponding different latency to access the second cache memory; and, a cache controller coupled to the first cache memory and the second cache memory to respond to cache access requests for data blocks, the cache controller to perform cache lookups in the first cache memory and the second cache memory concurrently.

### Example 2

The apparatus of example 1, wherein the first cache memory returns data in response to a cache access request before the second cache memory returns the data in response to the cache access request and the cache controller uses the data from the first cache memory.

### Example 3

The apparatus of example 1, wherein the second cache memory returns data in response to a cache access request before the first cache memory returns the data in response to the cache access request and the cache controller uses the data from the second cache memory.

### Example 4

The apparatus of example 1, wherein the cache memory controller is configured to store any given cache line in only one of the first cache memory and the second cache memory.

### Example 5

The apparatus of example 4, wherein if a cache line is evicted from the first cache memory the cache line is stored by the cache controller in the second cache memory.

### Example 6

The apparatus of example 4, wherein if a cache line in the second cache memory meets an access threshold, the cache line is evicted from the second cache memory and stored in the first cache memory.

### Example 7

The apparatus of example 1, wherein the cache memory controller is configured such that a cache line may be stored in both the first cache memory system and the second cache memory.

### Example 8

The apparatus of example 7, wherein if a cache line in the second cache memory meets an access threshold, the cache line is stored in the first cache memory without evicting the cache line from the second cache memory.

### Example 9

A method of operating a cache memory system, comprising: storing a cache line in at least one of a first cache memory and a second cache memory, the first cache memory having a first cache storage array and a first cache tag array, the second cache memory having a second cache storage array and a second cache tag array; setting an operating mode of the second cache memory to a first one of a plurality of operating modes, the plurality of operating modes each having a different power consumption and corresponding different latency to access the second cache memory; concurrently performing cache lookups for the cache line in the first cache memory and the second cache memory; and, receiving the cache line from the one of the first cache memory and the second cache memory that returns the cache line first.

### Example 10

The method of example 9, wherein the cache line is stored in the first cache memory, the method further comprising: in response to evicting the cache line from the first cache memory, storing the cache line in the second cache.

### Example 11

The method of example 9, wherein the cache line is stored in the second cache memory, the method further comprising: in response to determining that the cache line meets an access threshold, evicting the cache line from the second cache memory and storing the cache line in the first cache memory.

### Example 12

The method of example 9, wherein the cache line is stored in the first cache memory and is not stored in the second cache memory, the method further comprising: in response to evicting the cache line from the first cache memory, storing the cache line in the second cache memory.

### Example 13

The method of example 9, wherein the cache line is stored in the second cache memory and is not stored in the first cache memory, the method further comprising: in response to determining that the cache line meets an access threshold, storing the cache line in the first cache memory without evicting the cache line from the second cache memory.

### Example 14

The method of example 9, wherein if the cache line is stored in the first cache memory and the second cache memory, and the second cache memory is in the first one of the plurality of operating modes, the first cache memory returns the cache line first.

### Example 15

The method of example 9, wherein if the cache line is stored in the first cache memory and the second cache memory, and the second cache memory is in a second one of the plurality of operating modes, the second cache memory returns the cache line first.

### Example 16

An integrated circuit, comprising: a first cache memory having a first access latency; a second cache memory having a variable access latency that is based on an operating mode of the second cache memory; and, a cache controller coupled to the first cache memory and the second cache memory, the cache controller configured such that, for a majority of cache accesses, the first cache memory and the second cache memory perform cache lookups concurrently.

### Example 17

The integrated circuit of example 16, wherein the cache controller is configured to maintain cache lines exclusively in one of first cache memory and the second cache memory.

### Example 18

The integrated circuit of example 17, wherein if a cache line is evicted from the first cache memory, the cache lines is then stored in the second cache memory in response to the cache line being evicted from the first cache memory.

### Example 19

The integrated circuit of example 17, wherein if a cache line in the second cache memory meets an access threshold, the cache line is evicted from the second cache memory and is then stored in the first cache memory in response to the cache line meeting the access threshold.

### Example 20

The integrated circuit of example 16, wherein if a cache line in the second cache memory meets an access threshold, the cache line is stored in the first cache memory in response to the cache line meeting the access threshold and the cache line is not evicted from the second cache memory in response to the storing of the cache line in the first cache memory.

The foregoing descriptions of the disclosed embodiments have been presented for purposes of illustration and description. They are not intended to be exhaustive or to limit the scope of the claimed subject matter to the precise form(s) disclosed, and other modifications and variations may be possible in light of the above teachings. The embodiments were chosen and described in order to best explain the principles of the disclosed embodiments and their practical application to thereby enable others skilled in the art to best utilize the various embodiments and various modifications as are suited to the particular use contemplated. It is intended that the appended claims be construed to include other alternative embodiments except insofar as limited by the prior art.

1. An apparatus for processing data, comprising:
a first cache memory comprising a first cache storage array and a first cache tag array;
a second cache memory comprising a second cache storage array and a second cache tag array, the second cache storage array having a higher storage capacity than the first cache storage array, the second cache memory having a plurality of operating modes each having a different power consumption and corresponding different latency to perform a cache line read from the second cache memory; and,
a cache controller coupled to the first cache memory and the second cache memory to respond to cache line read requests for cache lines, the cache controller to perform cache lookups in the first cache memory and the second cache memory concurrently.

2. The apparatus of claim 1, wherein the first cache memory returns cache lines in response to a cache line read request before the second cache memory returns the cache lines in response to the cache line read request and the cache controller uses the cache lines from the first cache memory.

3. The apparatus of claim 1, wherein the second cache memory returns cache lines in response to a cache line read request before the first cache memory returns the cache lines in response to the cache line read request and the cache controller uses the cache lines from the second cache memory.

4. The apparatus of claim 1, wherein the cache memory controller is configured to store any given cache line in only one of the first cache memory and the second cache memory.

5. The apparatus of claim 4, wherein if a cache line is evicted from the first cache memory the cache line is stored by the cache controller in the second cache memory.

6. The apparatus of claim 4, wherein if a cache line in the second cache memory meets an access threshold, the cache line is evicted from the second cache memory and stored in the first cache memory.

7. The apparatus of claim 1, wherein the cache memory controller is configured such that a cache line may be stored in both the first cache memory and the second cache memory.

8. The apparatus of claim 7, wherein if a cache line in the second cache memory meets an access threshold, the cache line is stored in the first cache memory without evicting the cache line from the second cache memory.

9. A method of operating a cache memory system, comprising:
storing a cache line in at least one of a first cache memory and a second cache memory, the first cache memory having a first cache storage array and a first cache tag array, the second cache memory having a second cache storage array and a second cache tag array;
setting an operating mode of the second cache memory to a first one of a plurality of operating modes, the plurality of operating modes each having a different power consumption and corresponding different latency to perform a cache line read from the second cache memory;
concurrently performing cache lookups for the cache line in the first cache memory and the second cache memory; and,
receiving the cache line from the one of the first cache memory and the second cache memory that returns the cache line first.

10. The method of claim 9, wherein the cache line is stored in the first cache memory, the method further comprising:
in response to evicting the cache line from the first cache memory, storing the cache line in the second cache memory.

11. The method of claim 9, wherein the cache line is stored in the second cache memory, the method further comprising:
in response to determining that the cache line meets an access threshold, evicting the cache line from the second cache memory and storing the cache line in the first cache memory.

12. The method of claim 9, wherein the cache line is stored in the first cache memory and is not stored in the second cache memory, the method further comprising:
in response to evicting the cache line from the first cache memory, storing the cache line in the second cache memory.

13. The method of claim 9, wherein the cache line is stored in the second cache memory and is not stored in the first cache memory, the method further comprising:
in response to determining that the cache line meets an access threshold, storing the cache line in the first cache memory without evicting the cache line from the second cache memory.

14. The method of claim 9, wherein if the cache line is stored in the first cache memory and the second cache memory, and the second cache memory is in the first one of the plurality of operating modes, the first cache memory returns the cache line first.

15. The method of claim 9, wherein if the cache line is stored in the first cache memory and the second cache memory, and the second cache memory is in a second one of the plurality of operating modes, the second cache memory returns the cache line first.

16. An integrated circuit, comprising:
a first cache memory having a first cache line read latency;
a second cache memory having a variable cache line read latency that is based on an operating mode of the second cache memory; and,
a cache controller coupled to the first cache memory and the second cache memory, the cache controller configured such that, for a majority of cache line read requests, the first cache memory and the second cache memory perform cache lookups concurrently.

17. The integrated circuit of claim 16, wherein the cache controller is configured to maintain cache lines exclusively in one of first cache memory and the second cache memory.

18. The integrated circuit of claim 17, wherein if a cache line is evicted from the first cache memory, the cache line is then stored in the second cache memory in response to the cache line being evicted from the first cache memory.

19. The integrated circuit of claim 17, wherein if a cache line in the second cache memory meets an access threshold, the cache line is evicted from the second cache memory and is then stored in the first cache memory in response to the cache line meeting the access threshold.

20. The integrated circuit of claim 16, wherein if a cache line in the second cache memory meets an access threshold, the cache line is stored in the first cache memory in response to the cache line meeting the access threshold and the cache line is not evicted from the second cache memory in response to the storing of the cache line in the first cache memory.
